(19) United States
(12) Patent Application Publication
(10) Pub. No.: US 2016/0138316 A1
(43) Pub. Date: May 19, 2016

(54) COVER HOLDER

(71) Applicant: DORMA Deutschland GmbH, Ennepetal (DE)

(72) Inventors: Andreas FINKE, Ennepetal (DE); Matthias DRUX, Ennepetal (DE); Jens KLOSSAS, Ennepetal (DE); Arne LIEBSCHER, Ennepetal (DE)

(21) Appl. No.: 14/939,045

(22) Filed: Nov. 12, 2015

(30) Foreign Application Priority Data
Nov. 14, 2014 (EP) 14193365.5

(51) Int. Cl. E05D 15/06; F16M 13/02

(52) U.S. Cl. CPC E05D 15/0652; F16M 13/02

(57) ABSTRACT

A cover holder for the releasable attachment, to a roller running path of a sliding door installation, including a basic body, wherein a holding portion for holding the roller running path is configured to the basic body. The cover holder includes a first attachment portion for the attachment to a first counter-attachment portion of the cover in a first attachment direction. The cover further includes a second attachment portion, spaced apart from the first attachment portion, for the attachment to a second counter-attachment portion of the cover in a second attachment direction configured at the basic body. The first and second attachment directions include a correlation angle in the range between 70° and 110°.

### FIELD

The present disclosure relates to a cover holder for the releasable attachment, in particular to a roller running path of a sliding door installation, relates to a corresponding cover, to a sliding door installation as well as to a method for mounting a cover to a roller running path.

### BACKGROUND

It is known to aim for protecting technical structural components against inspection, against the action of dust or mechanical damage. Covers are provided for this purpose, which can be attached to such structural components in a covering position. Conventional sliding doors include roller running paths on which one or more roller carriages are supported to be displaceable. With the intention to protect said roller carriages appropriately, a cover is affixed, which offers protection against inspection, soiling or mechanical action. Usually, said covers are screwed to the roller running path and are thus attached in a reversible manner.

Conventional covers are disadvantageous in that the mounting procedure is relatively time consuming. It is for example required to place two, however often considerably more threaded bolts and to screw them into corresponding threaded holes. Moreover, a mounting tool in the shape of a screwdriver or a cordless screwdriver is necessary. Last but not least, the complexity during the mounting procedure is even increased by the plurality of individual small screws. All of the above results in a higher time expense and in an increased complexity, as well as in a corresponding higher error rate, when attaching such covers.

The present disclosure provides a device to improve the mountability of such a cover in a cost-efficient and simple way.

### SUMMARY

Features and details of the disclosure will become apparent from the dependent claims, the description and the drawings. In this case, features and details, described in conjunction with the inventive cover holder are obviously also valid in conjunction with the inventive cover, with the inventive sliding door installation, as well as with the inventive method, and respectively vice versa, such that mutual reference is made, respectively can be made with respect to the disclosure of individual aspects of the disclosure. An inventive cover holder serves for the releasable attachment, in particular to a roller running path of a sliding door installation. Such a cover holder includes for this purpose a basic body, wherein a holding portion for holding the roller running path is configured at the basic body. Furthermore, a first attachment portion for the attachment to a first counter-attachment portion of the cover in a first attachment direction is provided, respectively configured at the basic body. Moreover, a second attachment portion, spaced apart from the first attachment portion for the attachment to a second counter-attachment portion of the cover in a second attachment direction, is configured at the basic body. The first attachment direction and the second attachment direction include a correlation angle in the range between 70° and 110°.

An inventive cover holder thus serves the purpose of replacing the conventional attachment means in the shape of screws, which were employed so far. In this case, the cover holder includes two basic functions. On the one hand, this is the holding function at the roller running path of a sliding door installation. On the other hand, it is the attachment function of the cover itself. This circumstance results in the possibility of integrating said two functions in the inventive cover holder separately from the roller running path and separately from the cover. Any complexity is thereby concentrated on the cover holder and can be provided at the latter by means of the geometrical configurations. This results in particular in being able to configure the structural components of the roller running path and of the cover in an inexpensive and simple manner, for example in the shape of an extruded profile.

According to the disclosure, the two functions should be distinguished in more detail from each other. Both functions, namely the holding function and the attachment function, are in this case preferably configured to be reversible. However, it is basically possible to configure at least one of the two functions, in particular the holding function as an irreversible affixing, such that the second functionality, namely with a fixable and irreversible holding function, the attachment function is configured to be reversible. In all said cases, it is still possible, after having attached a cover to a roller running path by means of an inventive cover holder, to subsequently remove said cover. This feature may be advantageous in the event of access required to inside located technical structural components, when a service or repair of a defect needs to be performed. In this case, in particular a reversible release of the installed attachment and/or of the holding function is/are realized without mechanical impairment of the individual structural components.

The functionality of the attachment will be further specified. This is achieved in that the attachment is divided into two basic components. A first attachment portion will provide a first part of the attachment function, and a second attachment portion will provide a second part of the attachment function. In this case, it should be pointed out that each of the two attachment portions includes a defined attachment direction. Said defined attachment direction includes a directional vector, which is aligned along an attaching movement, namely for example when configuring a snap-latch-functionality for the respective attachment portion this is the direction, which provides said snap-latch-functionality. In this case, with corresponding large opening angles, the attachment directions may be configured within an attachment direction range in the shape of an opened angle segment. Based on the inventive correlation of two different attachment directions of the two separate attachment portions, accordingly a mounting movement is made possible, which includes said two attachment movements. According to the idea of the present disclosure, the entire movement, which includes a plurality of individual movements and attaches the cover to the roller running path by means of the cover holder, is understood by mounting movement. In this case, an attachment movement is understood to include specific individual movements of the mounting movement, which respectively result in forming the attachment function of the respective attachment portion.

According to the disclosure, the mounting movement is subdivided into at least two attachment movements, which based on their geometrical configuration of the different attachment directions have different attachment directions. This circumstance results in that in particular an essentially vertical orientation of the two attachment directions with regard to each other entails a correspondingly high safety against unwanted removal. After latching both attachment portions, a mutual stabilization will be given such that the other attachment portion, based on its correspondingly correlating different attachment direction, prevents releasing one attachment portion. In order to release such an attachment, a defined procedure is necessary, in which the explicit reversed order of the mounting movement is performed. In this case, a mounting movement is in particular conceived such that the two attachment movements take place at different times. When performing the mounting movement, firstly a first attachment movement is performed for the first attachment portion, and only once it is completed, a second attachment movement is performed for the second attachment portion.

In this case, according to the idea of the present disclosure, an attachment portion is in particular understood as a snap-latch-functionality.

Said functionality may be provided in that one or more attachment branches form respectively one attachment portion. In this case, such a snap-latch-functionality may be provided in particular by means of a corresponding elastic configuration of individual material portions, respectively attachment branches of the respective attachment portion. Different technical solutions may be intended for the respective attachment portion, according to the idea of the present disclosure.

The holding function is guaranteed by the holding portion and may be likewise configured as a snap-latch-functionality. However, other technical solutions, such as a friction connection, a non-positive connection and/or a form closure are applicable according to the idea of the present disclosure. Obviously, different functionalities may be combined for the holding portion.

According to the idea of the present disclosure, the correlation angle is the angle between the two attachment directions. In other words, the respective attachment direction is configured to be in particular vertical or essentially vertical with regard to the correlating attachment movement of the other attachment portion. Setting a correlation angle in the range between 70° and 110° will achieve in this case the inventive advantage of mutual stabilization. In this case, said correlation angle spans in a plane, which the two vectors of the attachment directions span. At a roller running path, said plane is vertical on the correspondingly configured attachment direction of a roller carriage on said roller running path. However, basically and obviously different orientations, in particular acute orientations, are possible in such a plane according to the idea of the present disclosure.

It is advantageous, if, in an inventive cover holder, the correlation angle ranges between 85° and 95°, in particular at approximately 90°. The more precise the configuration, respectively the orientation of the correlation angle in the range of a vertical correlation, the stronger the mutual stabilization according to the present disclosure. An exact vertical configuration results in that the subsequently reversible performable dismounting is essentially based on an explicit reversed order of the individual movements for the individual attachment movements of the mounting movement. When performing the mounting procedure, this represents a simplification, because an attachment and a sequence of the individual attachment movements will likewise take place in a defined and in particular preferably guided manner.

Furthermore, it is advantageous, if, in an inventive cover holder, the basic body includes a locating surface for bearing against a counter-surface of the cover. In this case, the locating surface is in particular disposed between the two attachment portions. With regard to its geometrical extension, such a locating surface correlates in this case with the counter-locating surface. This means that said two surfaces are configured to be complementary or at least sectionwise complementary. Here, they particularly include flat surfaces. In this case, such a correlation between the locating surface and the counter-locating surface may in particular provide for a mechanical stabilization in the mounted condition. Moreover, additional portions, in particular edges of the cover holder, may glide off the counter-locating surface such that a guiding functionality is guaranteed in this way for performing the mounting movement, respectively for parts of the mounting movement. In such a case, the counter-locating surface acts as a guiding means for the mounting procedure, respectively for the attachment of the cover holder to the cover.

Moreover, it is advantageous, if, in an inventive cover holder, the wall thickness of the basic body presents at least one of the following ratios:
portion of the locating surface: a first attachment branch of the first attachment portion in a range between 0.5 and 1.5
portion of the locating surface: a second attachment branch of the first attachment portion in a range between 0.5 and 1.5
portion of the locating surface: a first attachment branch of the second attachment portion in a range between 0.5 and 1.5
portion of the locating surface: a second attachment branch of the second attachment portion in a range between 0.5 and 1.5
portion of the locating surface: the holding portion in a range between 0.5 and 3.

The above enumeration is a non-exhaustive listing. In particular a range between 0.75 and 1.25 is intended for the correlation between the locating surface and the respective attachment branches. For said ratio, a respective range between 0.9 and 1.1 is preferred. For the ratio between the locating surface and the holding portion, in particular a range between 1 and 2.5, particularly preferred a range between 1 and 2 might be intended. In particular a majority of the present configuration of the basic body, is configured with an identical or essentially identical wall thickness. In case different wall thicknesses are intended, they are configured with just small wall thickness steps within the above limits such as to allow for simplified manufacturing of the cover holder. In this way, in particular in an inexpensive and simple embodiment, an injection molding method and thereby a cover holder made from plastic material, in particular thermoplastic material, can be employed.

It is moreover advantageous, if, in an inventive cover holder, the first attachment portion and/or the second attachment portion each present a first attachment branch and a second attachment branch. In this case, the two attachment branches include in particular an attachment angle in the range between 75° and 290°. The larger said attachment angle is dimensioned, the more freedom in the orientation during attachment. The larger said attachment angle, the wider a corresponding vector range is dimensioned, in which the inventive attachment direction is configured. If such a configuration is intended, a particularly wide attachment angle provides simplified mountability. In case the attachment angle is chosen in a smaller range, a correspondingly smaller choice of potential attachment directions is defined for a reduction of a corresponding angle range for the attachment vector. In this case, an increased safety of the cover holder is guaranteed in the attachment condition. In particular a corresponding attachment angle allows for a pivoting movement prior to performing the subsequent and final attachment movement.

Another advantage may be provided, if, in an inventive cover holder, the first attachment portion and/or the second attachment portion are configured for a positive and/or non-positive attachment to the respective counter-attachment portion, in particular in the shape of a snap-latch-connection. In this case, in particular attachment branches of the attachment portions are provided for such a snap-latch-connection. Positive and/or non-positive attachments can be provided for example in that the respective attachment portion is formed, in one part or in an attachment branch, in an elastically manner. This results in an elastic deformation, wherein the elastic return forces in the respective material provide the latching in the shape of a latching movement. Provision of a snap-latch-connection for one or both attachment portions results moreover in higher safety during the mounting procedure, because both, haptic and acoustic feedbacks, generated by the latching, indicate the end of the respective attachment movement.

It is likewise advantageous, if, in an inventive cover holder, the holder portion for a pivoting and/or rotating attachment to a roller running path includes a plate-shaped extension having a width, which is smaller than the length of said plate-shaped extension. In a rotary motion or in a pivotal movement, the holding portion thus serves to fulfill the corresponding holding function. For example an associated groove may be configured at the roller running path. The holding portion, with its smaller width extension, is now introduced into said groove. In a pivoting movement or in a rotary motion, in particular in the range up to approximately 90°, the long side may be now oriented in such a way that the holding portion is retained within the groove. This means, the groove is preferably at least on one, and preferably on both sides, configured with an undercut, into which the corresponding frontal sides of such a plate-shaped holding portion can engage. In this case, it may be likewise a form closure, which is combined, in particular perfectly fitting, with a friction connection. Basically however, it is likewise possible that the holding portion includes freedom of movement within such a groove, such that said holding portion is supported to be displaceable in the groove. After setting the holding function, namely after inserting the holding portion into the groove, this circumstance simplifies guaranteeing subsequent lateral displacement. In this way, the flexibility is increased during the mounting procedure.

It is furthermore advantageous, if, in an inventive cover holder, the basic body is configured to be monolithic and forms the holding portion, the first attachment portion and/or the second attachment portion in an integral manner. In this case, a monolithic respectively integral configuration is understood as a configuration in one piece. This refers in particular to a single material for all said structural component portions. Basically however, it is likewise conceivable to produce, by means of a multi-component injection molding method, a multi-material configuration for such a monolithic form of the basic body. Basically, the monolithic configuration has important advantages for reducing the manufacturing complexity, for example with regard to an injection molding process.

Another advantage is provided, if, in an inventive cover holder, the basic body, in particular in the area of the holding portion, includes at least two reinforcing ribs for the mechanical reinforcement, which preferably extend parallel to each other. If such a holding portion is for example provided with a locating surface, which points in the direction of a bottom of a corresponding groove of the roller running path, said side could be identified as the front side. The corresponding backside is preferably reinforced by means of said embodiment with the at least two reinforcing ribs. The mechanical reinforcement serves the purpose of saving material with the rib-shape and in particular of guaranteeing an advantageous wall thickness correlation with regard to the transition areas in an injection molding method. The parallel configuration results likewise in providing a simplified molding for the injection molding process.

Furthermore, it is advantageous, if, in an inventive cover holder, the two attachment portions are configured for two at least partially different attachment movements. In this case, in particular the type of attachment movement is concerned such that, on the one hand, the first attachment movement is realized preferably purely translatory or at least at the end translatory. The second attachment movement with regard to the second attachment portion is in this case preferably at least partially provided to be pivotally or rotary. In this way, the two separate attachment types of the two attachment portions can be distinguished from each other even better, whereby in particular the dismounting is provided in a defined manner and most of all in a secured manner.

Another subject matter of the present disclosure is a cover for covering a roller running path of a sliding door installation. Such a cover includes a first counter-attachment portion for attaching a first attachment portion of a cover holder according to the present disclosure along a first attachment direction. Furthermore, a second counter-attachment portion is provided for attaching a second attachment portion of said cover holder along a second attachment direction. The two attachment directions include a correlation angle in the range between 70° and 110° By employing an inventive cover holder, an inventive cover offers the same advantages as those explained in detail in relation to an inventive cover holder. Obviously, also two or more cover holders can be provided for the attachment.

A further subject matter of the present disclosure is a sliding door installation, including a roller running path and at least one roller carriage, which is supported to be displaceable in the roller running path. An inventive sliding door installation is distinguished in that the roller running path is covered by a cover according to the present disclosure, which is attached with at least one cover holder according to the present disclosure. An inventive sliding door installation has the same advantages as the ones explained in detail with regard to an inventive cover holder.

A method for mounting a cover to a roller running path of a sliding door installation is likewise a subject matter of the present disclosure, including the following steps:
attaching a cover holder according to the present disclosure to the roller running path,
attaching a first attachment portion of the cover holder along a first attachment direction to a first counter-attachment portion of the cover,
attaching a second attachment portion of the cover holder along a second attachment direction to a second counter-attachment portion of the cover.

By employing an inventive cover holder, an inventive method offers the same advantages as those explained in detail in relation to an inventive cover holder.

It may be advantageous, in an inventive method, if the attachment of the cover holder to the roller running path is realized by means of a rotary attachment movement in the range between 15° and 135°. Said rotary movement allows for providing an explicit distinction between a displaceable and/or translatory attachment movement of the attachment portions, as will be explained in the following. In this case, in particular a rotary movement is performed about an axis, which is essentially provided along the direction of gravity in the mounted position of the roller running path. A rotation is preferably performed in the range of approximately 90°±10°, in order to provide an unambiguous distinction between the different positions and to provide simultaneously a reduced extension of the necessary attachment movement.

The inventive method is advantageously furthermore developed in that the attachment of the attachment portion is realized in the following way:
attaching the first attachment portion of the cover holder along the first attachment direction to the first counter-attachment portion of the cover by means of a displacing attachment movement, in particular with a pivoting range of less than 10°, and/or
attaching the second attachment portion of the cover holder along the second attachment direction to the second counter-attachment portion of the cover by a rotation about the first attachment portion.

The two above mentioned attachment steps may be performed both in combination as well as individually. In this case, it is again pointed out in what way the correlation of different attachment directions provides a defined attachment order for the entire mounting movement. The dismounting procedure is realized according to the disclosure in the reversed order. Therefore, a corresponding method for dismounting the cover is likewise a subject matter of the present disclosure, wherein the above description is performed correspondingly to the individual movement in the reversed order for such a dismounting method.

### BRIEF DESCRIPTION OF THE DRAWINGS

Further advantages, features and details of the disclosure will result from the following description, in which exemplary embodiments of the disclosure are described in detail, reference being made to the drawings. disclosure In the drawings:

FIG. 1 an embodiment of a cover holder,

FIG. 2 an embodiment of FIG. 1 in a lateral illustration,

FIG. 3 the embodiment of FIGS. 1 and 2 with the cover being attached,

FIG. 4 the embodiment of the FIGS. 1 to 3 in a lateral illustration in the mounted position to the roller running path,

FIG. 5 the situation during the insertion of the holding portion,

FIG. 6 the situation when performing the first attachment movement,

FIG. 7 the situation when performing the second attachment movement, and

FIG. 8 the situation shortly prior to performing the mounting.

### DETAILED DESCRIPTION OF THE DRAWINGS

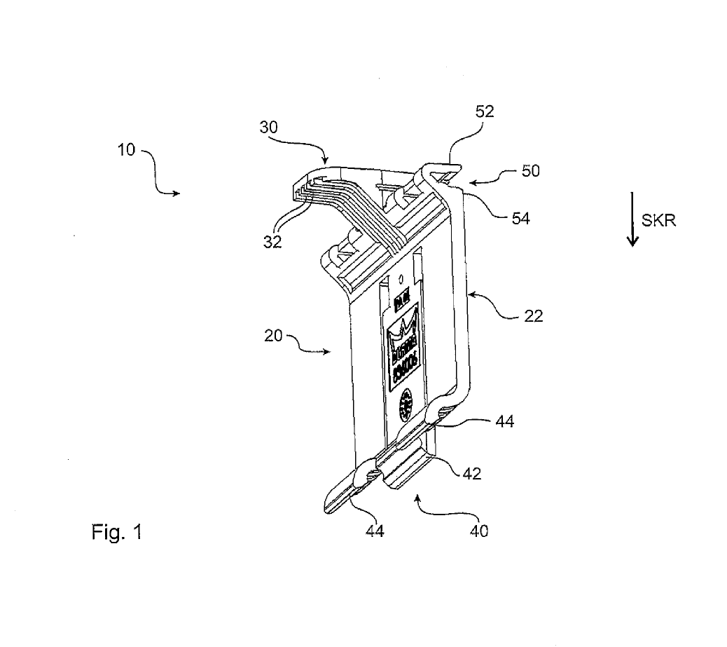

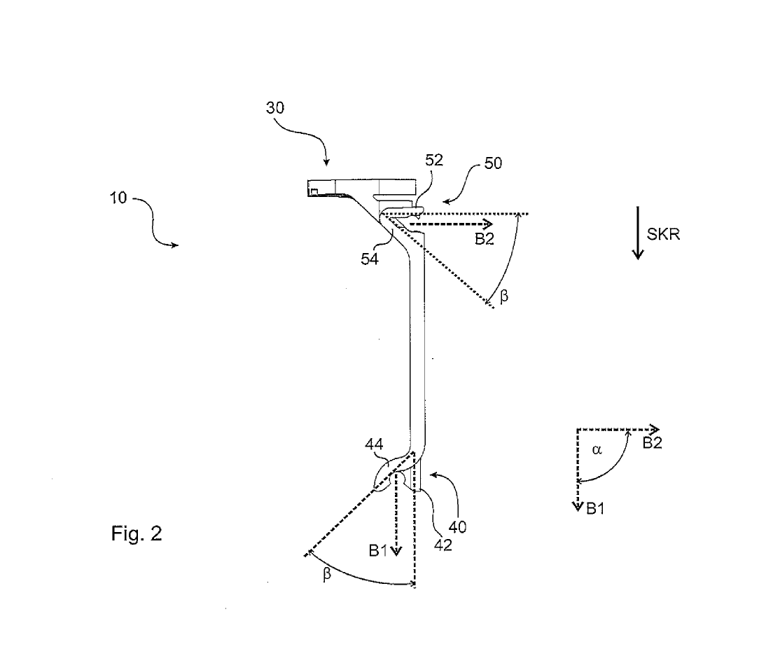

A first cover holder 10 is illustrated in the FIGS. 1 and 2. It is equipped with a basic body 20, which is provided in this case in an injection molding process as a plastic material component. Respectively one attachment portion 40 and 50 is provided at the top and at the bottom ends, wherein at the top end projecting to the left, additionally the holding portion 30 is visible. Moreover, for mechanical stabilization, the holding portion 30 is provided with a plurality of reinforcing rips 32, which provide for a corresponding mechanical stabilization.

The two attachment portions 40 and 50 are equipped in this case with a snap-latch-functionality. This means, that the first attachment portion 40 includes a first attachment branch 42 and a second attachment branch 44, in this case two attachment branches 44. In the same way, the second attachment portion 50 is equipped with a first attachment branch 52, respectively with two such second attachment branches 52 and with a second attachment branch 54.

Moreover, it can be seen that the basic body 20 presents an essentially flat longitudinal extension, which, on the backside, is provided with a locating surface 22. In this case, the direction of gravity SKR is seen in relation to the corresponding mounting situation when installing such a cover holder 10.

FIG. 2 shows now the correlation of the resulting angle in such a cover holder 10. The first attachment portion 40 is provided here with two attachment branches 44 and 42, which among each other include a corresponding attachment angle β. The two attachment branches 52 and 54 of the second attachment portion 50 also define such an attachment angle β. Said two attachment angles β may be configured differently and they are preferably provided in the range between 75° and 290°.

FIG. 2 illustrates likewise the two attachment directions B1 and B2 of the two attachment portions 40 and 50, which are vertical to each other, such that the correlation angle α between the two attachment directions B1 and B2 amounts to 90° in this case. This circumstance results in the possibility for the entire mounting movement, as will be explained later.

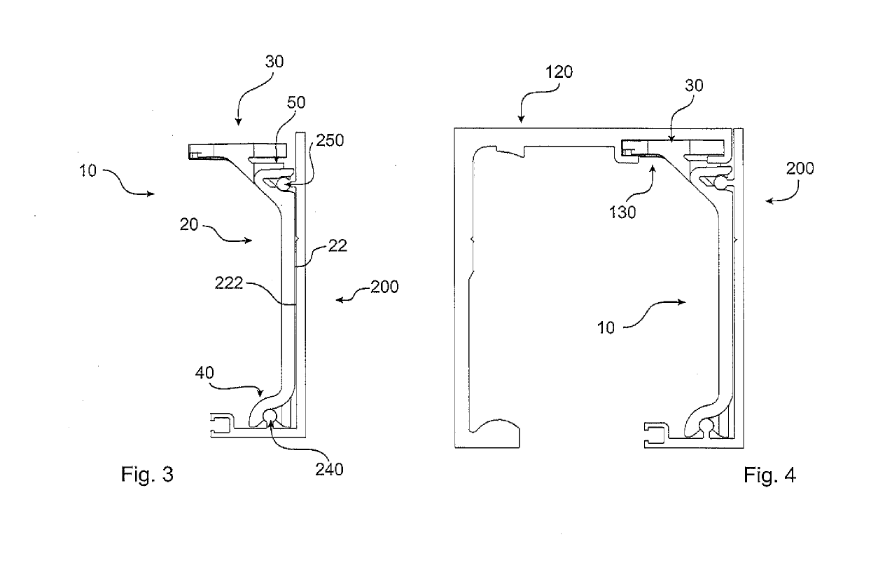

FIGS. 3 and 4 illustrate the correlation of such a cover holder 10 with further structural components. FIG. 3 thus shows how a corresponding locating surface 22 reaches placement at a corresponding counter-locating surface 222 of the cover 200. This arrangement results in the already explained mechanical stabilization in the attached position. By means of corresponding circular rib configurations in cross-section, in this case the counter-attachment portions 240 and 250 are provided, to which the two attachment portions 40 and 50 are already latched.

FIG. 4 shows the completed holding function, in which the holding portion 30 is disposed at an associated holding groove 130 of the roller running path 120.

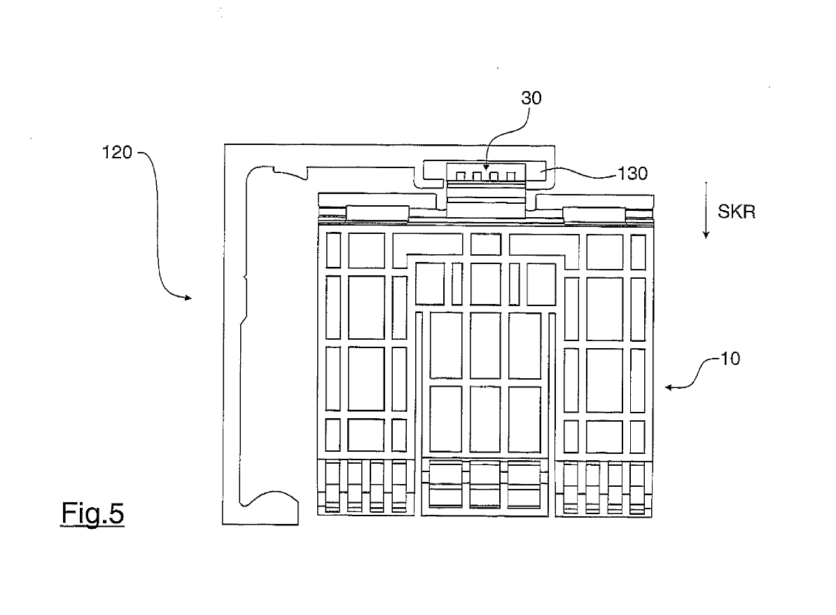

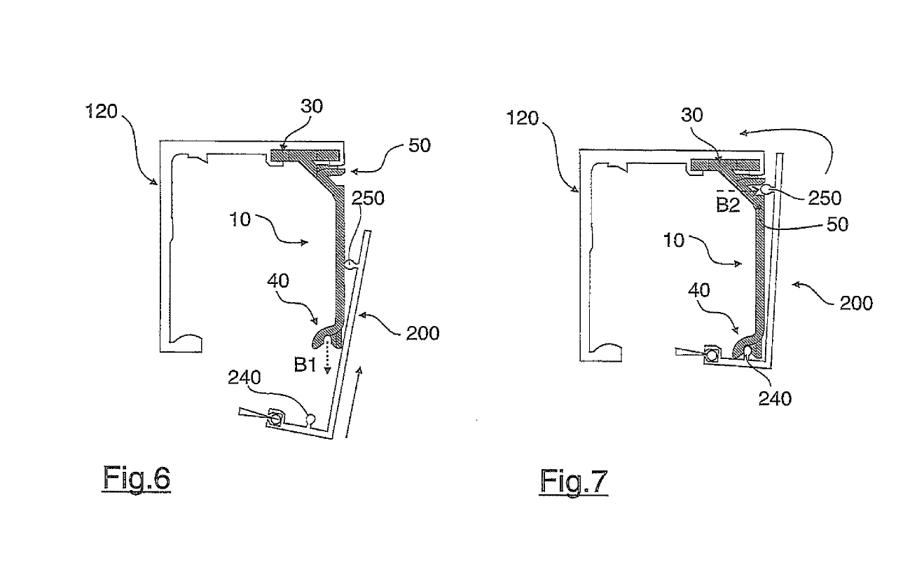

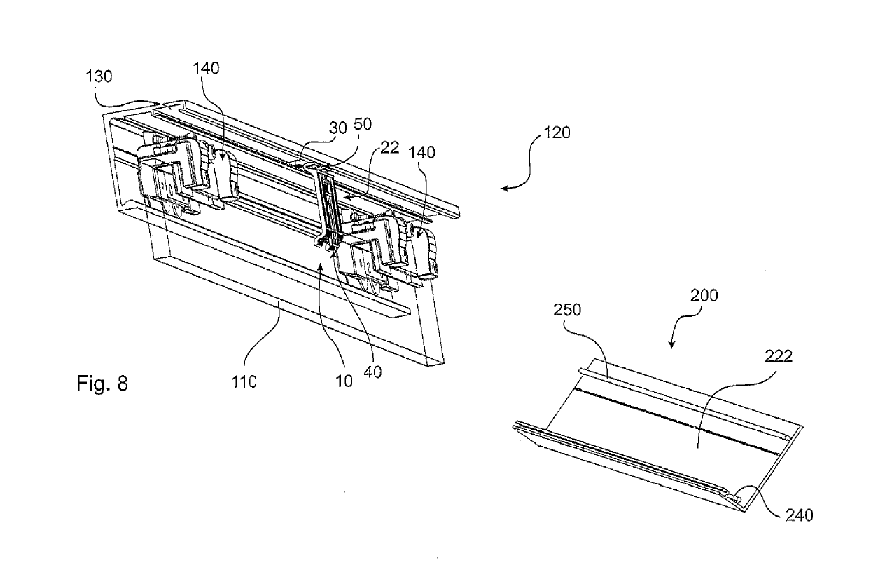

Based on the FIGS. 5 to 8, the attachment, respectively the mounting will now be explained in more detail. In a first step according to FIG. 5, the holding portion 130 of the cover holder 10 with the short broad side is inserted into the associated holding groove 130. A rotation about a rotational axis, oriented in the direction of gravity SKR in FIG. 5, realizes a fixing of the holding portion 30 in the respective undercut of the holding groove 130. A situation as illustrated in FIG. 8 on the left top side, respectively in FIG. 6 is achieved. In this case, it may be advantageous, if, in said position, the cover holder 10 may remain axially displaceable.

The cover 200 is then being attached. The cover 200 is illustrated in FIG. 8 on the bottom right, and is now ready to be attached. For said attachment, the counter-locating surface 222 as well as the counter-attachment portions 240 and 250 are provided. In this case, the first part of the mounting movement is illustrated in FIG. 6, which part is essentially realized in a displacing, respectively translatory manner. At the end of said attachment, a latching is performed, wherein said latching represents the attachment movement along the first attachment direction B1. The result of said movement, which, as the first part of the mounting movement, is guided by means of gliding on the counter-locating surface 222, is illustrated in FIG. 7. FIG. 7 shows furthermore the connecting terminal part of the attachment movement, wherein based on the rotation arrow, now a rotation of the cover 200 is generated about the first attachment portion 40. In this case, the second attachment portion 50 now latches in the counter-attachment portion 250 along the second attachment direction B2. FIG. 4 shows the end of said movement, as the finally fixed position.

The above description of the mounting movement may be performed as well in the reversed order, with the intention to guarantee in the inventive manner also a dismounting of the cover.

The above explanation of the embodiments describes the present disclosure exclusively based on examples. In this case, individual features of the embodiments, as long as technically reasonable, can be combined independently of each other, without leaving the scope of the present disclosure.

1. A cover holder for the releasable attachment to a roller running path of a sliding door installation, including a basic body, wherein a holding portion for holding the roller running path is configured at the basic body, wherein furthermore a first attachment portion for the attachment to a first counter-attachment portion of the cover in a first attachment direction, and a second attachment portion, which is spaced apart from the first attachment portion, for the attachment to a second counter-attachment portion of the cover in a second attachment direction is configured at the basic body, wherein the first attachment direction and the second attachment direction include a correlation angle in the range between 70° and 110°.

2. The cover holder according to claim 1, wherein the correlation angle is in the range between 85° and 95°.

3. The cover holder according to claim 1, wherein the basic body includes a locating surface for placement against a counter-locating surface of the cover, wherein the locating surface is disposed between the two attachment portions.

4. The cover holder according to claim 3, wherein the wall thickness of the basic body presents at least one of the following ratios:
portion of the locating surface: a first attachment branch of the first attachment portion in the range between 0.5 and 1.5
portion of the locating surface: a second attachment branch of the first attachment portion in the range between 0.5 and 1.5
portion of the locating surface: a first attachment branch of the second attachment portion in the range between 0.5 and 1.5
portion of the locating surface: a second attachment branch of the second attachment portion in the range between 0.5 and 1.5
portion of the locating surface: the holding portion in the range between 0.5 and 3.

5. The cover holder according to claim 1, wherein the first attachment portion and/or the second attachment portion each include a first attachment branch and a second attachment branch, wherein the two attachment branches include an attachment angle in the range between 75° and 290°.

6. The cover holder according to claim 1, wherein the first attachment portion or the second attachment portion are configured for a positive or non-positive attachment to the respective counter-attachment portion, in the shape of a snap-latch-connection.

7. The cover holder according to claim 1, wherein the holding portion presents a plate-shaped extension with a width, which is smaller than the length of said plate-shaped extension, for a pivoting and/or rotating attachment to the roller running path.

8. The cover holder according to claim 1, wherein the basic body is configured to be monolithic and is configured with the holding portion (30), the first attachment portion and/or the second attachment portion in an integral manner.

9. The cover holder according to claim 1, wherein the basic body, in the area of the holding portion, presents at least two reinforcing ribs for the mechanical reinforcement, extending parallel to each other.

10. The cover holder according to claim 1, wherein the two attachment portions are configured for two at least partially different attachment movements.

11. A cover for covering a roller running path of a sliding door installation, including a first counter-attachment portion for the attachment of a first attachment portion of a cover holder having the features of claim 1, along a first attachment direction, furthermore including a second attachment portion for the attachment of a second attachment portion of said cover holder along a second attachment direction, wherein the first attachment direction and the second attachment direction include a correlation angle in the range between 70° and 110°.

12. A sliding door installation, including a roller running path, and at least one roller carriage, which is supported in the roller running path to be displaceable, wherein the roller running path is covered, at least partially, by a cover having the features of claim 11, which is attached by means of at least one cover holder.

13. A method for mounting a cover at a roller running path of a sliding door installation, including the following steps:
attaching a cover holder having the features of claim 1 to the roller running path,
attaching a first attachment portion of the cover holder along a first attachment direction to a first counter-attachment portion of the cover,
attaching a second attachment portion of the cover holder along a second attachment direction to a second counter-attachment portion of the cover.

14. The method according to claim 13, wherein the attachment of the cover holder to the roller running path is realized by means of a rotary attachment movement in the range between 15° and 135°.

15. The method according to claim 13, wherein the attachment of the attachment portions is realized as follows:
attaching the first attachment portion of the cover holder along the first attachment direction to the first counter-attachment portion of the cover by means of a displacing attachment movement, with a pivoting range of less than 10°, and/or
attaching the second attachment portion of the cover holder along the second attachment direction to the second counter-attachment portion of the cover by a rotation about the first attachment portion.
